(19) United States
(12) Patent Application Publication
(10) Pub. No.: US 2026/0266113 A1
(43) Pub. Date: Sep. 10, 2026

(54) Lift-and-Lower Hinge for Supporting a Glass Door

(71) Applicant: BOHLE AG, Haan (DE)

(72) Inventors: Frank Windmann, Langenfeld (DE); Nils Pahnke, Essen (DE)

(73) Assignee: BOHLE AG, Haan (DE)

(21) Appl. No.: 19/663,771

(22) Filed: Apr. 30, 2026

(30) Foreign Application Priority Data
Apr. 30, 2005 (DE) 10 2025 116 771.0

(51) Int. Cl. E05D 5/10; E05D 7/02

(52) U.S. Cl. CPC E05D 5/10; E05D 7/02; E05D 2005/102; E05Y 2201/638

(57) ABSTRACT

A lift-and-lower hinge (10) for supporting a glass door comprises a first hinge part (12) with a bearing means (14) that has a vertical opening (14a) in which a pivot axle assembly (16) with a vertical bearing axis (16a) is rotatably received. Curve profiles (17) on the end faces of the pivot axle assembly (16), together with a bolt assembly (26) in a leg (22, 24) of a second hinge part (18), enable a lift-and-lower motion of the glass door. In this process, the rotation of the second hinge part (18) relative to the first hinge part (12) causes a defined lifting or lowering of the door, thereby achieving improved sealing effect and reduced wear. A flexible and low-maintenance application is made possible by a mirror-symmetrical design, bolt assemblies (26) that can be formed as a single piece or in multiple parts, detent positions in the curve profile (17), and the ability to swing open on both sides.

### CROSS REFERENCE TO RELATED PATENT APPLICATIONS

This application claims priority to German Patent Application 10 2025 116 771.0 filed on Apr. 30, 2025 entitled “Hebe-Senk-Band zur Lagerung einer Glastür” (Lift-and-Lower Hinge for Supporting a Glass Door) by Frank Windmann and Nils Pahnke, the entire disclosure of which is incorporated herein by reference in its entirety.

### BACKGROUND OF THE INVENTION

### 1. Field of the Invention

The following descriptions relate to a lift-and-lower hinge for supporting a glass door, in particular for swing doors and similar applications in the fields of shower enclosures, interior design, or furniture construction, where controlled vertical movement is desired during the opening and closing of the door.

Furthermore, the descriptions relate to the use of a pivot axle assembly, a bolt assembly, a first hinge part, and a second hinge part for the aforementioned lift-and-lower hinge.

### 2. Description of Related Art

DE 20 2007 001 139 U1 discloses a shower partition with a hinge into which a lifting mechanism is integrated. The lifting mechanism consists of two cam discs mounted coaxially on the hinge pin, whose adjacent cam surfaces run against each other when the door element is swung open, causing the door to be lifted vertically. The door element can swing in both directions about a vertical pivot axis.

With glass doors, for example in shower enclosures or in high-end interior design, the problem of precise yet low-maintenance support often arises. Conventional door hinges often do not allow for controlled height adjustment. Consequently, if floor unevenness or building settlement occurs, misalignments can result that impair closing accuracy. Furthermore, a high sealing effect is, in particular, desired in shower enclosures, which can be supported by a defined lowering motion during closing.

Furthermore, users prefer a flush-mounted design in which no components protrude from the glass pane. Such a design facilitates cleaning and gives the structure a modern, minimalist aesthetic. A two-way swing function is also advantageous in many cases, allowing the door to open both inward and outward. This not only contributes to flexibility in tight spaces but can also be safety-relevant (e.g., in an emergency).

Another key aspect is the design for different hinging arrangements. Many existing lift-and-lower hinges must be manufactured and stocked separately for left-hand hinging (also known as DIN left) or right-hand hinging (also known as DIN right), which poses significant organizational and economic challenges for manufacturers and distributors. If changes are needed at short notice on the construction site, if there have been delivery errors or incorrect orders, or if installation errors occur, a suitable strip may not be available. This results in delays and additional costs.

This creates a need for a lift-and-lower hinge that, on the one hand, generates a defined lift-and-lower motion to improve the sealing effect and reduce wear, in particular on sealing profiles. On the other hand, it should offer universal compatibility for DIN left and DIN right with just a few simple steps, without requiring additional components or a completely different hinge to be kept in stock.

Based on this situation, the object is to propose a lift-and-lower hinge that improves the height adjustment of the glass door and reduces the mechanical load on the pivot axle assembly. At the same time, it should be possible to mount the glass door on either side and design it to be flush with the surface, aesthetically pleasing, and easy to maintain.

### SUMMARY OF THE INVENTION

The present object is achieved by the features of the independent claims. Advantageous embodiments are described in the dependent claims, the description, and the drawings. Where technically feasible, the features of the dependent claims or the description may be combined in any manner with the features of the main and dependent claims.

In particular, the object is thus achieved by a lift-and-lower hinge for supporting a glass door, which comprises at least one first hinge part with a bearing means arranged thereon, wherein the bearing means comprises a continuous vertical opening for supporting a pivot axle assembly. Furthermore, the lift-and-lower hinge comprises at least one pivot axle assembly with a vertical bearing axis, wherein the pivot axle assembly is configured to rotatably connect the first hinge part to a second hinge part. In this context, the pivot axle assembly comprises, on each end face, a curve profile with at least one curve crest and one curve trough.

The lift-and-lower hinge further comprises at least one second hinge part having a U-shape with a base and two legs, wherein the second hinge part is rotatably connected to the bearing means, at least indirectly via the pivot axle assembly. Each leg comprises a respective horizontal leg recess configured for supporting a bolt assembly, and a respective vertical leg recess for supporting the pivot axle assembly. The pivot axle assembly, the vertical bearing axis, and the two vertical leg recesses are coaxial with one another. In this context, the pivot axle assembly forms a physical component, and the corresponding vertical leg recesses each form a receptacle for this physical component, such that it is understood from the description that the rotational axes of the pivot axle assembly and the vertical leg recesses substantially coincide. In other words, the vertical bearing axis corresponds to the axis of rotation or forms the aforementioned rotational axes.

Furthermore, at least one bolt assembly is provided, configured to be selectively insertable into one of the two horizontal leg recesses so as to interact, when inserted into one of the two horizontal leg recesses, with the curve profile of the pivot axle assembly in such a way that a rotation of the second hinge part relative to the first hinge part, in particular about the vertical bearing axis, is accompanied simultaneously by a vertical offset of the second hinge part relative to the first hinge part. In particular, the bolt assembly, when inserted into the respective horizontal leg recess, and the corresponding horizontal leg recess are coaxial with one another. For example, both have a substantially circular cross-section. It may also be the case that both components, in particular the horizontal leg recess, have a cross-sectional geometry different from a circular cross-section, for example an oval cross-section. In this case, the bolt assembly forms a physical component and the corresponding horizontal leg recess forms a receptacle for this physical component.

In particular, the horizontal leg recess and the vertical leg recess abut against each other and/or intersect within a respective leg, so that components arranged therein, for example the pivot axle assembly in the vertical leg recess and the bolt assembly in the horizontal leg recess, can interact with one another.

In other words, the lift-and-lower hinge is a hinge for a glass door that enables a controlled lift-and-lower motion during the opening and closing process. The special design of the pivot axle assembly, featuring a curve profile, creates a vertical displacement that is guided by a bolt assembly through a horizontal leg recess. The second hinge part, with a U-shaped structure, is rotatably connected to the first hinge part, whereby the vertical and horizontal leg recesses allow for a defined movement of the pivot axle assembly. The specific shaping of the curve crests and curve troughs influences the movement characteristics, so that the door opens and closes in a specific, advantageous manner. A particular advantage here is the U-shaped design of the second hinge part with the two horizontal leg recesses formed to accommodate the bolt assembly. Thus, the lift-and-lower hinge can be converted from a lift-and-lower hinge with left-hand hinging to a lift-and-lower hinge with right-hand hinging, and vice versa, by changing the bolt assembly from the bolt assembly receptacle/horizontal leg recess of one leg to the bolt assembly receptacle/horizontal leg recess of the second leg. It is no longer necessary to produce or stock two different lift-and-lower hinges.

A key advantage of the proposed lift-and-lower hinge is its simple conversion from a DIN-left configuration to a DIN-right configuration without additional components. This adjustment can be made in just a few steps directly on site and increases both flexibility during installation and cost-effectiveness in inventory management.

To perform the conversion, the second hinge part is first swung toward the first hinge part until the bolt assembly located in the upper horizontal leg recess is accessible. This bolt assembly is removed before the entire lift-and-lower hinge is rotated 180 degrees about the central horizontal plane of the hinge. As a result, the previously upper leg moves downward and the previously lower leg moves upward. The bolt assembly is then inserted into the now upper horizontal leg recess so that it once again engages with the curve profile on the end face of the pivot axle assembly.

Through this simple mechanical adjustment, the lift-and-lower hinge can be converted from a DIN-left to a DIN-right configuration and vice versa. The same hinge can thus be used equally for left-hand or right-hand hinged doors without the need to manufacture or stock different hinge models. Furthermore, the conversion requires no special tools or complex installation steps, which provides installers and users alike with significant time savings and increased flexibility.

A lift-and-lower hinge is, in particular, a fitting that enables both rotatable support and controlled height adjustment of a door. In the present context, the lift-and-lower hinge is, in particular, designed such that it performs a lifting mechanism when the door is opened and a lowering mechanism when it is closed.

A glass door is, in particular, a transparent door made of glass or laminated glass, typically used in shower enclosures, interior spaces, or furniture. In the present context, the door can, in particular, be mounted as flush as possible without protruding hardware components.

A first hinge part is, in particular, a part of the lift-and-lower hinge that is usually fixed to a fixed structure, such as a wall or a door frame, or alternatively to a fixed glass component. The first hinge part carries the bearing means and serves as a connection for the pivot axle assembly.

A bearing means is, in particular, a component arranged on the first hinge part and having a vertical opening for supporting the pivot axle assembly. The bearing means can be fixed in one or more planes and forms the basis for the rotatable support.

A vertical opening is, in particular, a through-opening that extends substantially in the vertical direction and serves to receive the pivot axle assembly via a form-fit and/or force-fit connection. It enables precise alignment of the pivot axle assembly, allowing a rotational and lifting motion to take place along a defined axis.

A pivot axle assembly is, in particular, a substantially cylindrical or elongated component that is arranged between the first and second hinge parts and enables both rotational and lift-and-lower motion. It features a curve profile on each end face to effect the defined lifting and lowering in conjunction with the bolt assembly. In other words, the pivot axle assembly has two end regions, each of which features the curve profile. In particular, the pivot axle assembly has a bolt-assembly guide head with a curve profile on one or both end faces. In particular, one bolt-assembly guide head or both bolt-assembly guide heads are each a detachably mountable or detachably mounted component of the pivot axle assembly, so that in the event of wear, an environmentally friendly replacement of individual components can be performed instead of a complete hinge replacement. Furthermore, the curve profile and thus the lift-and-lower behavior can be adjusted as needed by selecting the appropriate bolt-assembly guide head. This allows a lift-and-lower hinge to be reused and then adapted to different conditions, such as varying substrate heights or glass pane lengths, which is also beneficial to the environment. In particular, the pivot axle assembly or any bolt-assembly guide head, or both bolt-assembly guide heads, may be designed as hollow profiles, solid profiles, or hollow profiles with end caps.

A vertical bearing axis is, in particular, the main axis of rotation of the pivot axle assembly, which is vertically aligned. The rotation of the second hinge part relative to the first hinge part takes place about this axis, while additional elements in the context of the curve profile generate the lift-and-lower moment.

A curve profile is, in particular, a configuration-defining region, preferably circumferential, on one or both end faces of the pivot axle assembly, which is curved or wave-shaped in at least one dimension. The curve profile is arranged at each end of the pivot axle assembly, interacts with the bolt assembly, and causes the vertical movement during opening and closing.

A curve crest is, in particular, a raised point or section within the circumferentially extending curve profile, the slope of which influences the upward movement of the bolt assembly. It serves to lift the bolt assembly as the two hinge parts rotate toward each other. This area determines, among other things, the maximum height to which the second hinge part is lifted during the opening movement. Although a curve crest has both an upward slope and a downward slope, in the present context, a curve crest, in particular, refers to that section of the curve profile with an increasing slope from the zero position; that is, the section of the curve crest that causes the upward movement of the second hinge part.

A curve trough is, in particular, a depression or section with a downward slope in the circumferential curve profile into which the bolt assembly moves as the two hinge parts rotate. The curve trough can, for example, define the detent position or a lower end position, allowing the door to remain lowered in a closed position. Although a curve crest has both an upward slope and a downward slope, the curve trough in this context, in particular, refers to that section of the curve profile with a decreasing slope starting from the curve crest; that is, the section of the curve trough that causes the downward movement of the second hinge part.

A second hinge part is, in particular, a further element of the lift-and-lower hinge that is rotatably connected to the first hinge part. The second hinge part is U-shaped and serves, in particular, to secure or mount the glass door leaf. It performs the defined lifting and lowering during rotation.

A U-shape is, in particular, a configuration of the second hinge part in which a base extends from two parallel legs and forms a contour resembling a “U” in cross-section. The legs are preferably parallel, but not necessarily so. U-like structures are also possible, for example a “V” with a point-like base. This U-shape provides space for the bearing means and the pivot axle assembly between the legs, while the base ensures stability and connects the legs.

A base is, in particular, the connecting section between the two legs of the second hinge part. The second hinge part can be attached to the glass door or to supplementary fastening components via the base and/or via the legs. The base may also feature structural reinforcements.

Legs are, in particular, two substantially parallel sections of the second hinge part that laterally encircle the bearing means together with the pivot axle assembly. Alternatively, an angle between the legs is also possible. The legs feature a horizontal leg recess and a vertical leg recess to accommodate the bolt assembly and the pivot axle assembly. The horizontal leg recess and the vertical leg recess of a leg are oriented such that their main axes are, in particular, orthogonal to one another. In particular, the vertical leg recess is oriented relative to the vertical bearing axis, preferably parallel or coaxial with it.

A horizontal leg recess is, in particular, a respective bore or milled groove in the legs that extends horizontally or is at least predominantly oriented in a horizontal direction. The bolt assembly can be inserted into this recess so that it can come into contact with the curve profile.

A vertical leg recess is, in particular, a respective bore or milled groove in the legs that runs substantially vertically, via which the pivot axle assembly is held coaxially with the vertical bearing axis. This recess creates a defined positioning and rotational guidance around the vertical bearing axis.

A bolt assembly is, in particular, a component that can be inserted into the horizontal leg recess and contacts the curve profile via its shape or position. The bolt assembly may be designed as a single-piece component or in multiple parts, for example as a fitting screw, pin, or screw pin, and guides the movement along the curve contour during rotation.

A vertical offset is, in particular, the vertical distance through which the second hinge part, and thus the glass door, traverses between the closed and the open state. The vertical offset is a direct result of the interaction between the bolt assembly and the curve profile and causes the intended lifting or lowering.

The previously defined object is thus achieved at least by the features of claim 1, since the interaction of the bolt assembly with the curve profile achieves precise control of the vertical offset during the rotation. This enables improved functionality of the hinge, in particular with regard to an automatic closing movement or improved sealing effect. At the same time, due to the interchangeable positioning of the bolt assembly, the same hinge type can be used for both DIN left and DIN right, which significantly reduces inventory and production costs and allows the installer to easily convert the setup on-site.

Accordingly, a lift-and-lower hinge is proposed, in particular a flush-mounted swing door lift-and-lower hinge, for supporting a glass door, in particular a frameless all-glass door such as a shower enclosure door. The lift-and-lower hinge is designed such that it features an integrated lift-and-lower mechanism and can be used as both a DIN-left and a DIN-right door hinge. This is achieved in particular through a symmetrical design of all essential components, thereby enabling left-to-right adjustability. In other words, the hinge can be easily converted on-site from one opening direction, for example left, to the other, for example right, and vice versa, without requiring any special additional components.

The lift-and-lower hinge is designed, for example, as a swing door hinge, so that the glass door can be opened in both directions, i.e., inward and outward. This offers the advantage, for example in a shower, that no water drips onto the bathroom floor when opening inward. The flush-mounted design ensures, in particular, that no components protrude into the interior of the shower area when the door is closed; the inner side of the glass door and the fitting attached to it form a continuous flat surface that can be easily cleaned, for example, using a squeegee or a similar tool. This results in an attractive appearance and prevents the formation of dirt edges.

The integrated lift-and-lower mechanism, through the interaction of the curve profile and the bolt assembly, causes the door leaf to lift slightly when the door is opened and to lower accordingly when closed. In this way, when the door is closed, the door leaf can rest on the threshold or floor with a seal attached at the bottom, ensuring a high level of watertightness. When opening, the seal is relieved by the lifting action, which minimizes friction and wear on the seal and allows for smooth opening.

Of course, a separate bolt assembly can be arranged in each horizontal leg recess, which is fixed in place as needed and after appropriate positioning of the lift-and-lower hinge, so that the basic concept is fulfilled. However, it is preferable to reposition a single bolt assembly. In other words, it is essential that a bolt assembly engages with the curve profile so that the lift-and-lower mechanism is formed.

This versatility saves storage space, reduces production and transportation costs, and makes on-site installation significantly more flexible.

Where recesses are mentioned, these may generally be understood as openings. It is not mandatory that these be created by material removal. It is possible that the component is cast, pressed, or otherwise produced directly with the recess; material removal is also possible, in particular by means of machining.

The phrase “substantially” means that the description following the phrase must be fulfilled in essence, but minor deviations are also permissible. However, full compliance with the description following the phrase “substantially” is always preferred.

Where ordinal numbers, such as “first,” “second,” etc., are used, for example to designate a component, an element, a process step, or a process operation, these ordinal numbers are intended purely for differentiation in the designation and do not indicate dependencies or sequences. This means, in particular, that, for example, a device does not need to have a “first component” in order to have a “second component.”

The following sections explain advantageous aspects, and preferred modified embodiments are described further below. Explanations, in particular regarding advantages and definitions of features, are essentially descriptive and preferred, but not limiting, examples. If an explanation is limiting, this is expressly stated.

Alternatively or additionally, it may be provided that the first hinge part, the pivot axle assembly, and/or the second hinge part are formed substantially mirror-symmetrically with respect to a central horizontal plane of the lift-and-lower hinge. A mirror-symmetrical design of individual or all hinge parts simplifies production because different components are not required for the left and right sides. The symmetry also enables an attractive appearance, as substantially the same components can be used for both a left-hand and a right-hand version. Additionally, a symmetrical geometry increases ease of maintenance because certain components can be easily replaced or moved to the other side without having to make extensive adjustments. This leads to cost-optimized series production and simultaneously reduces inventory.

Alternatively or additionally, the bolt assembly is formed in multiple parts, in particular comprising a screw and a pin, or as a single-piece fitting screw, in order to enable flexible installation. The bolt assembly plays a key role in transmitting force from the curve profile to the second hinge part. A design in multiple parts, such as a screw plus pin, allows for fine adjustment when compensating for different component tolerances. At the same time, a cost-effective single-piece fitting screw solution can be offered if particularly fast assembly or lower production costs are the priority. Manufacturers can thus respond flexibly to different customer requirements, for example when a particularly high load-bearing capacity or improved adjustment options are desired.

Alternatively or additionally, it may be provided that the curve profile comprises a waveform with varying curve crest and/or curve trough slopes. The wave-shaped design of the curve profile allows for individual adjustment of the lift-and-lower behavior to specific requirements, e.g., door weight, desired closing characteristics, or seal pressure. Different slopes in the curve crest or curve trough areas of the curve create a stepped lifting effect. This can, for example, allow for an initial moderate lift upon opening, followed by a more pronounced lift at a further rotational position. Latching effects can also be specifically incorporated through varying slopes.

Alternatively or additionally, the pivot axle assembly is formed monolithically or in one piece, in particular detachably in one piece. A monolithic pivot axle assembly, e.g., machined from a metal block or manufactured by casting, promises high stability and dimensional accuracy because weld seams, screw connections, or adhesive joints can be eliminated. This reduces potential weak points and minimizes maintenance requirements. At the same time, one-piece manufacturing is cost-effective when producing large series and proves to be particularly robust in practice against mechanical stresses, such as those occurring during the frequent swinging of a glass door.

Alternatively or additionally, it may be provided that the pivot axle assembly comprises an axle and, on each end face, a bolt-assembly guide head arranged on the axle, wherein each bolt-assembly guide head comprises a curve profile on its end face. If a bolt-assembly guide head with a curve profile is formed on each end face of the pivot axle assembly, a symmetrical load distribution is achieved. This design is, in particular, recommended for larger or heavier glass doors, as the force absorption is distributed across two areas. Furthermore, the dual design of the curve profile provides redundant functionality: should one side wear out, at least a certain basic function of the lift-and-lower mechanism remains intact. Additionally, fine adjustment of the door position can be achieved via the different positions of the bolt assembly on the two heads.

Alternatively or additionally, it may be provided that the curve profile comprises at least one or more detent positions for the bolt assembly to hold the glass door in the closed position. Through one or more defined detent positions, the door leaf can be securely held in a specific position, in particular in the closed position. This is advantageous for shower enclosures to prevent the door from opening unintentionally. Alternatively or additionally, a latching mechanism in an open position may be provided, for example for cleaning purposes. The latching mechanism also reduces the force required to hold the door, thereby increasing user comfort.

Alternatively or additionally, the curve profile comprises at least two, in particular exactly two, curve crests and at least two, in particular exactly two, curve troughs as a continuous waveform. A curve profile with exactly two curve crests and two curve troughs offers a particularly compact design that still allows for different intermediate positions of the door. For example, a first curve crest can generate an initial lift during slight opening, while the second curve crest causes an even greater lift at a wider opening angle. Two defined curve troughs can represent separate detent positions. This simplifies the design and reduces production costs, as a complicated, multiple-wave contour is not required.

Alternatively or additionally, it may be provided that the curve profile comprises an even number of curve crests and an even number of curve troughs as a continuous waveform. An even number of curve crests and curve troughs allows for a symmetrical design of the curve profile. This is, in particular, suitable for swing doors, as it allows the behavior to be standardized in two swing directions (inward and outward). As a result, the lift-and-lower hinge can exhibit similar lifting and lowering characteristics in both directions of rotation. This synergy makes it particularly convenient for users, as the door can be opened in either direction with the same feel.

Alternatively or additionally, it may be provided that the curve profile comprises at least two diametrically opposed curve crests and curve troughs. Diametrically opposed formations in the curve profile provide a defined balance between two swing directions. This is very useful in the case of a door that swings in both directions, because the same mechanism applies when opening to the left or to the right. The symmetrical design also simplifies on-site installation, as the profile exhibits the same lifting and lowering characteristics in all relevant positions. Furthermore, even wear is achieved, as the load is distributed across two opposing areas. Furthermore, the lift-and-lower hinge can be used in this way, in particular, as both a left-hand hinge and a right-hand hinge without any deviation in its swinging characteristics.

Alternatively or additionally, it may be provided that the curve profile comprises at least two or more diametrically opposed curve troughs to automatically hold the glass door in the closed position. If diametrically opposed curve troughs are included in the design, the door can be positioned in a closed position in both directions. Among other things, this enables a two-way swing function, in which the door automatically returns to the closed position from both directions. This is highly desirable in shower applications, for example, so that the door does not remain open and water leakage is prevented. Furthermore, even wear is achieved, as the load is distributed across two opposing areas. Additionally, the lift-and-lower hinge can be used in this manner, in particular, as both a left-hand hinge and a right-hand hinge, without any deviation in its swinging characteristics.

Alternatively or additionally, it may be provided that at least one curve crest, preferably several curve crests, most preferably all curve crests, in particular in the region of their apex, each comprises or comprise a flat, in particular of bowl-shaped configuration. The respective flat on the curve crests is arranged in particular at the highest point of the curve crest's slope, serves as a detent position, and preferably reduces friction at the contact point between the bolt assembly and the curve profile, facilitating a smooth transition between different detent or height positions. This not only protects the involved components but also has a positive effect on ease of use. This results in smooth engagement or disengagement, thereby significantly reducing jerking or clicking noises.

Alternatively or additionally, it may be provided that the lift-and-lower hinge comprises at least one spring element and/or damping element in the region of the pivot axle assembly or the bolt assembly to assist or dampen the opening and/or closing. By integrating a spring, the hinge can be additionally supported during opening, as the spring stores energy and releases it again during closing. Conversely, a damping element, e.g., a hydraulic or pneumatic damper, can prevent the door from slamming shut too quickly. These measures increase safety, in particular when children or elderly people operate the door, and reduce mechanical stress. Low maintenance is maintained despite these additional elements, provided the components are robustly designed for use in damp or wet environments, e.g., in shower stalls.

Alternatively or additionally, it may be provided that the second hinge part is designed to allow the glass door to swing open on both sides, such that the glass door can be swung out of the closed position in both a first direction and an opposite direction. A two-way swing function increases ease of use in rooms with limited space and improves safety because, in an emergency, the door opens in both directions. This is, in particular, advantageous in hotel bathrooms, sauna areas, or accessible restrooms. The hinge's universal applicability is further enhanced, as no special hardware is required for one-sided opening. Combined with the ability to use the hinge on the left or right, this creates a flexible solution that accommodates a wide variety of installation configurations.

Alternatively or additionally, it may be provided that at least one or more stop means is/are provided, which limit the rotation of the second hinge part in at least one or both directions of rotation. Stop means ensure that the door is not opened beyond a certain angle to prevent collisions with walls, furniture, or other components. This is, in particular, important in tight installation situations. Such stops can be mechanical, e.g., a pin that engages in a cutout, or integrated into the curve profile.

Alternatively or additionally, it may be provided that the second hinge part and the first hinge part are formed such that, in a closed position, they are substantially flush with an adjacent surface. The closed position refers to the zero position of the lift-and-lower hinge. Flush designs are in line with trends in modern architecture and bathroom fixtures, as they are aesthetically pleasing and offer hygienic advantages (easier cleaning). Additionally, potential dirt or limescale buildup on protruding edges is eliminated. This design requires precise coordination of the hinge geometry, which is, however, facilitated by the described lift-and-lower technology.

Alternatively or additionally, it may be provided that an adjustment means is provided to readjust the position of the second hinge part relative to the first hinge part in a transverse direction or in the direction of the vertical bearing axis. The ability to make adjustments at a later stage extends the service life of the entire system and allows for the compensation of tolerances in the installation environment. Should the building settle or the door warp slightly, the installer can correct the position of the second hinge part using a screw, eccentric bolt, or other mechanism. This allows the closing profile to be maintained permanently and increases operational reliability (in particular sealing and secure closing contact). This is a significant competitive advantage, as it reduces problems caused by warped doors or jamming.

Alternatively or additionally, the pivot axle assembly is substantially dumbbell-shaped, comprising two end-face bolt-assembly guide heads and a narrower axle section located between them. The dumbbell-shaped design of the pivot axle assembly ensures efficient force transmission because the wider area on the end faces, i.e., the guide heads, serves as the contact zone for the bolt assembly, while the narrower central section allows for a certain degree of freedom of movement for the swing and lift-and-lower functions. This design increases stability and reduces the risk of bending stresses in the center. Furthermore, installation is straightforward, as the bolt assembly can be threaded onto or through the outer heads, while the central axle section can be easily inserted into the vertical opening. Here, too, the advantage of the universal orientation becomes apparent: the dumbbell-shaped geometry can be used on either the left or right side without any issues.

Alternatively or additionally, it may be provided that the lift-and-lower hinge, in its operating state, i.e., after the lift-and-lower hinge has been installed, or, in other words, after its assembly state, comprises exactly one bolt assembly in the upper horizontal leg recess. In this case, the lift-and-lower hinge, in its assembly state, additionally comprises a second bolt assembly in the second horizontal leg recess, which prevents a vertical offset between the first hinge part and the second hinge part during installation or before installation is complete. To this end, in the assembly state of the lift-and-lower hinge, its components, in particular both bolt assemblies, are arranged in the horizontal leg recesses such that they are each positioned in the curve trough of the curve profile associated with them. The operating state refers in particular to the state in which the lift-and-lower hinge, for example while supporting a glass pane, is in daily operation. The assembly state is defined as the state prior to the lift-and-lower hinge being secured, in particular screwed, to its final substrate with its first hinge part. In particular, the lift-and-lower hinge transitions from the assembly state to the operating state after the first hinge part has been secured to its final substrate, in particular by screwing, and/or after the lower bolt assembly has been removed from the lower horizontal leg recess. The lower bolt assembly thus loses its locking function, which is due to the fact that without this second bolt assembly, the first hinge part must be held up in a stabilizing manner during installation. Without this lower bolt assembly, the hinge parts must therefore, according to an exemplary embodiment, first be aligned and screwed into place on the panel body to be installed, in particular designed as a glass door. The panel body is then moved into the desired position and aligned, in particular using a spirit level and/or glazing blocks. Finally, the positions of the drill holes for the first hinge part are marked. The problem here is that, without the present design, the first hinge part must be actively held in place. After marking the drill holes, the panel body is repositioned, the holes are drilled, and the panel body can be installed. It is conceivable that alternative fastening methods, such as welding, could be used instead of drill holes. In particular, when the lift-and-lower hinge is delivered, both bolt assemblies are installed or at least included for installation. The bolt assemblies lock the lift-and-lower mechanism, preventing the lift-and-lower hinge from moving up or down, or allowing only minimal movement; this is relative to the first hinge part. Consequently, it is not yet determined whether the lift-and-lower hinge is designed for DIN right or DIN left. This allows the installer to mount the lift-and-lower hinge as if it had no lift-and-lower function. As soon as the installer removes the lower bolt assembly, in particular unscrews it, the blockage of the lift-and-lower function is removed, and the lift-and-lower hinge functions as described in the remainder of this disclosure, in particular adjustable as DIN right or DIN left, depending on the installation position. In other words, the lower bolt assembly must be removed to transition from the assembly state to the operating state, regardless of whether the lift-and-lower hinge is to be used in the DIN right or DIN left configuration. As a result, the installer can more easily attach the lift-and-lower hinge to the substrate, in particular by screwing it on, because the first hinge part, in particular designed as a mounting plate, is positioned as it would be in the non-raised/vertically offset position.

The listed features enable a wide variety of configurations to adapt the proposed lift-and-lower hinge even better to different installation and application scenarios. In particular, the combinable features such as symmetrical design, bolt assemblies formed as a single piece or in multiple parts, wave-shaped curve profiles, and/or integrated spring elements or stop means result in high flexibility and low maintenance requirements. Since these features support conversion from left to right without major modifications, significant cost savings and logistical advantages result for manufacturers and users. The design of the curve shape, e.g., a straight series of curve crests, diametrically opposed curve crests and curve troughs, further contributes to a versatile and advantageous mechanism that experiences minimal wear, is easy to install, and provides high ease of use.

Furthermore, the embodiments relate to the use of a pivot axle assembly, a bolt assembly, a first hinge part, and a second hinge part for the aforementioned lift-and-lower hinge.

### BRIEF DESCRIPTION OF THE DRAWINGS

A preferred technical solution is described in more detail below with reference to the accompanying drawings and based on preferred embodiments. The term “figure” is abbreviated as “Fig.” in the drawings.

The drawings show

FIG. 1 a side view of a first embodiment of a lift-and-lower hinge, assembled as DIN left;

FIG. 2 a perspective view of the lift-and-lower hinge according to the first embodiment, assembled as DIN left;

FIG. 3 the lift-and-lower hinge of the first embodiment, wherein a bolt assembly is removed from an upper leg;

FIG. 4 the lift-and-lower hinge of the first embodiment, wherein the lift-and-lower hinge is rotated 180 degrees relative to the view shown in FIG. 3, with the bolt assembly inserted into the now upper leg, which was the lower leg in FIG. 3;

FIG. 5 a perspective view of the lift-and-lower hinge according to the first embodiment, assembled as DIN right;

FIG. 6 a side view of the first embodiment of the lift-and-lower hinge, assembled as DIN right;

FIG. 7 a partially transparent side view of the first embodiment of the lift-and-lower hinge, assembled as DIN left;

FIG. 8 a partially transparent side view of the lift-and-lower hinge, analogous to FIG. 7, but with a modified bolt assembly;

FIG. 9 a partially transparent perspective view of the lift-and-lower hinge according to the first embodiment;

FIG. 10 an enlarged section of the lift-and-lower hinge as shown in FIG. 9, but from a different perspective of the lift-and-lower hinge and with the second hinge part in a different rotational position;

FIG. 11 an enlarged section of the lift-and-lower hinge according to FIG. 9, but shown from a different perspective of the lift-and-lower hinge and with the second hinge part in a different rotational position;

FIG. 12 a bolt-assembly guide head of a pivot axle assembly for the lift-and-lower hinge shown in FIGS. 1 through 11;

FIG. 13 a perspective view of the bolt-assembly guide head according to FIG. 12 with a bolt assembly guided therein for the lift-and-lower hinge shown in FIGS. 1 through 11;

FIG. 14 the bolt-assembly guide head and the bolt assembly of FIG. 13, wherein the bolt assembly is rotated horizontally by 90 degrees; and

FIG. 15 the pivot axle assembly with the bolt-assembly guide head according to FIGS. 12 to 14, arranged in a bearing means of a first hinge part of the lift-and-lower hinge according to FIGS. 1 to 11;

FIG. 16 a perspective view of the lift-and-lower hinge according to the first embodiment in an assembly state, in which, in addition to the first bolt assembly in the upper horizontal leg recess, a second bolt assembly is arranged in the lower horizontal leg recess;

FIG. 17 a perspective view of the lift-and-lower hinge without a second bolt assembly in the lower horizontal leg recess, wherein a vertical offset between the first hinge part and the second hinge part is apparent; and

FIG. 18 a perspective view of the lift-and-lower hinge according to FIG. 17 in an assembly state with the second bolt assembly inserted, wherein the vertical offset between the first hinge part and the second hinge part is prevented by the second bolt assembly.

### DESCRIPTION OF THE PREFERRED EMBODIMENTS

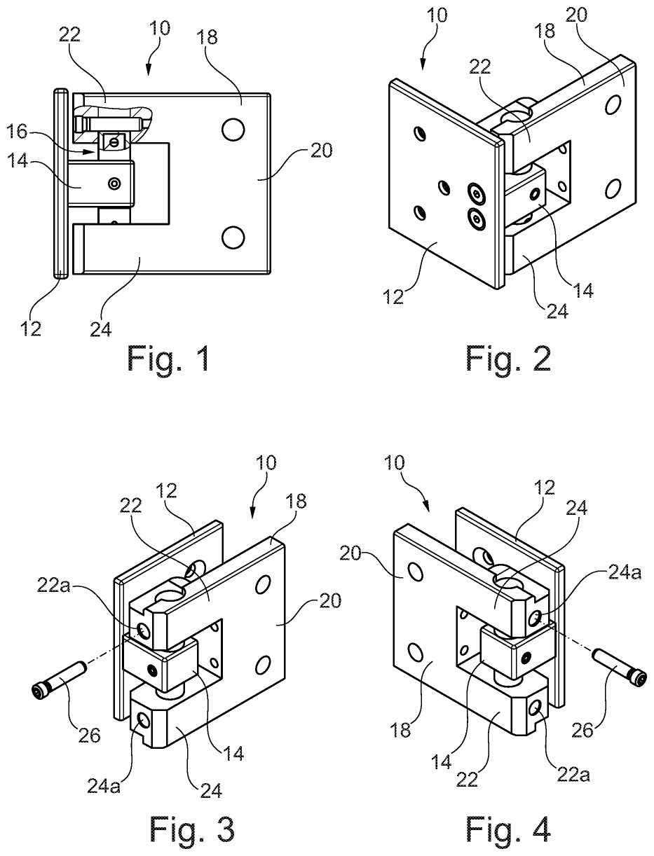

The described embodiments are merely examples that may be modified and/or supplemented in various ways within the scope of the claims. Any feature described for a particular embodiment may be used independently or in combination with other features in any other embodiment. Any feature described for an embodiment of a specific claim category may also be used in a corresponding manner in an embodiment of another claim category. Any graphical differences between the figures shown are attributable to the symbolic nature of patent drawings. To the extent possible, the graphical disclosure of individual features is to be understood as a concrete technical configuration of components. All FIGS. 1 through 15 are to be assigned to a lift-and-lower hinge of a single embodiment, wherein only the bolt assembly varies between FIGS. 7 and 8.

FIGS. 1 through 11 show that a lift-and-lower hinge 10 is provided for supporting a glass door, comprising at least one first hinge part 12 with a bearing means 14 arranged thereon, wherein the bearing means 14 comprises a continuous vertical opening 14a for supporting a pivot axle assembly 16. The pivot axle assembly 16, with a vertical bearing axis 16a, rotatably connects the first hinge part 12 to a second hinge part 18, wherein the pivot axle assembly 16 comprises, on each end face, a curve profile 17 with at least one curve crest 17.1 and one curve trough 17.2. A second hinge part 18 has a U-shape with a base 20 and two legs 22 and 24 and is rotatably connected to the bearing means 14, at least indirectly via the pivot axle assembly 16. Each leg 22, 24 comprises a respective horizontal leg recess 22a, 24a configured for supporting a bolt assembly 26, and a respective vertical leg recess 22b, 24b for supporting the pivot axle assembly 16. The pivot axle assembly 16, the vertical bearing axis 16a, and the two vertical leg recesses 22b, 24b are coaxial with one another. Furthermore, a bolt assembly 26 is provided, configured to be selectively insertable into one of the two horizontal leg recesses 22a, 24a so as to interact, when inserted into one of the two horizontal leg recesses 22a, 24a, with the curve profile 17 of the pivot axle assembly 16 in such a way that a rotation of the second hinge part 18 relative to the first hinge part 12 is accompanied simultaneously by a vertical offset of the second hinge part 18 relative to the first hinge part 12.

As shown in the figures, the first hinge part 12, the pivot axle assembly 16, and/or the second hinge part 18 may be constructed in a mirror-symmetrical manner with respect to a central horizontal plane 10a. In this context, the bolt assembly 26 may be designed as a single-piece fitting screw or in multiple parts, e.g., as a screw and a pin, see in particular FIG. 7, to meet various installation and maintenance requirements. Furthermore, in a preferred embodiment, the curve profile 17 of the pivot axle assembly 16 has a waveform with at least two curve crests 17.1 and at least two curve troughs 17.2 to generate a defined lift-and-lower motion.

It can be seen in FIG. 8 that the pivot axle assembly 16 may be manufactured monolithically and, if necessary, has, on each end face, a bolt-assembly guide head 30.1 and 30.2, between which a narrower axle section 28 is located. This enables a uniform transfer of force into both legs 22, 24. Although not shown in detail, a spring element or damping element may be provided in the region of the pivot axle assembly 16 or the bolt assembly 26 to assist or slow down the closing process.

As can also be inferred from the figures, the second hinge part 18 can be swung open on both sides, so that the glass door opens inward and outward. Stop means (not shown) can limit the swinging in one or both directions. In the closed position, the glass door can lie flush against an adjacent surface, enabling a discreet aesthetic. For precise alignment when installed, an adjustment means may be provided that allows for adjustment in the transverse direction or along the vertical bearing axis 16a.

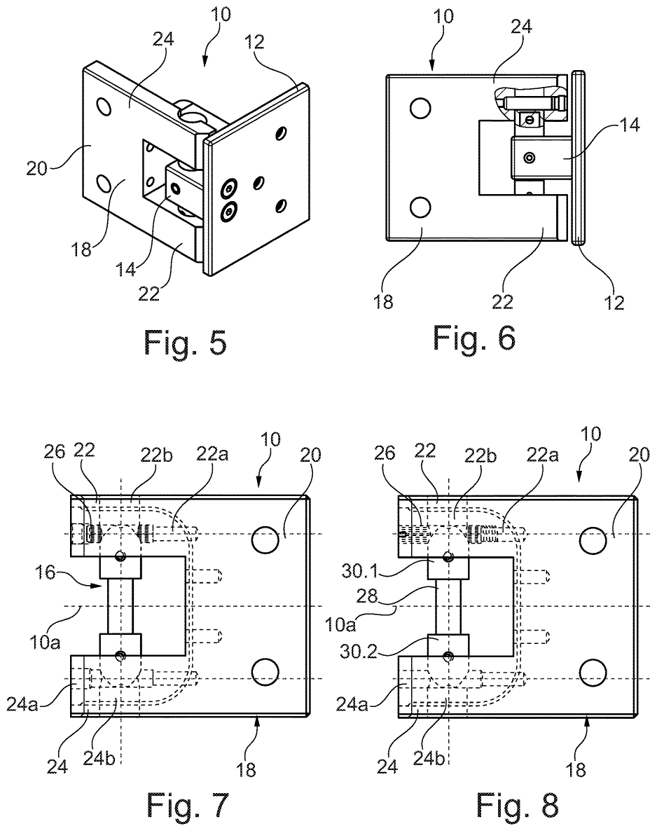

If a lift-and-lower hinge 10 (DIN left) is available, see FIGS. 1 and 2, the second hinge part 18 can first be swung or moved toward the first hinge part 12 to the extent that the bolt assembly 26, located in the horizontal leg recess 22a of the originally upper leg 22, is exposed and, as shown in FIG. 3, removed from the second hinge part 18. The lift-and-lower hinge 10 can then be rotated about the central horizontal plane 10a, in particular by 180 degrees, such that the originally upper leg 22 now forms the lower leg and the originally lower leg 24 now forms the upper leg. FIG. 4 shows the rotated lift-and-lower hinge 10, wherein the bolt assembly 26 is inserted into the horizontal leg recess 24a of the originally lower leg 24, which is now the upper leg. In doing so, the bolt assembly 26 is inserted until the bolt assembly 26 engages with the bolt-assembly guide head 30.1, 30.2 of the pivot axle assembly 16; see, for example, FIGS. 7 through 11 in various views. From this point on, the lift-and-lower hinge 10 is DIN right, as shown, for example, in FIGS. 5 and 6. Similarly, the lift-and-lower hinge 10 can also be switched from DIN left to DIN right.

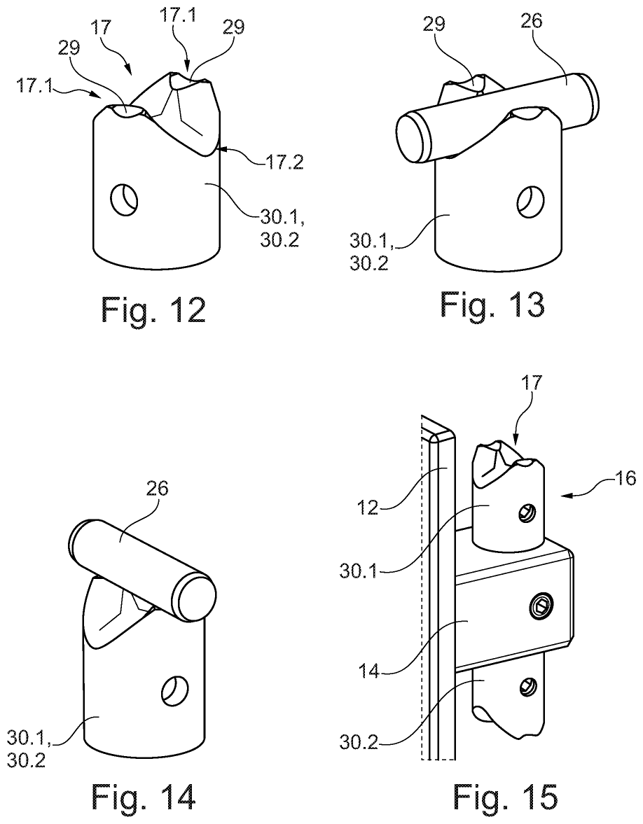

FIG. 12 shows a bolt-assembly guide head 30.1, 30.2 of a pivot axle assembly 16 with the curve profile 17 arranged on its end face. The curve profile 17 comprises two curve crests 17.1 and two curve troughs 17.2, which are, in particular, arranged diametrically opposite one another and, in particular, in a uniform waveform relative to one another. The two curve crests 17.1 each feature a flat 29.

FIG. 13 shows the bolt-assembly guide head 30.1, 30.2 according to FIG. 12 with a bolt assembly 26, which is located in the two diametrically opposed curve troughs 17.2. As a result, the lift-and-lower hinge 10 is in a detent position or rest position.

FIG. 14 shows the bolt-assembly guide head 30.1, 30.2 with the bolt assembly 26 as shown in FIG. 12 or FIG. 13 in a further rotated position, wherein it lies in the two diametrically opposed curve crests 17.1. The bolt assembly 26 rests on the two flats 29 of the curve crests 17.1. As a result, the lift-and-lower hinge 10 is in a detent position or rest position.

FIG. 15 shows the pivot axle assembly 16 arranged in the bearing means 14.

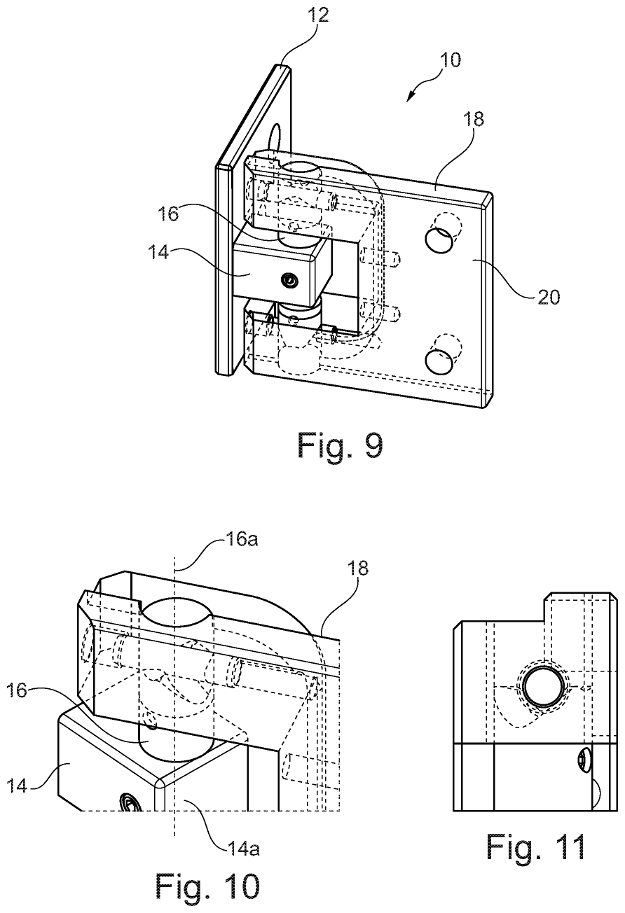

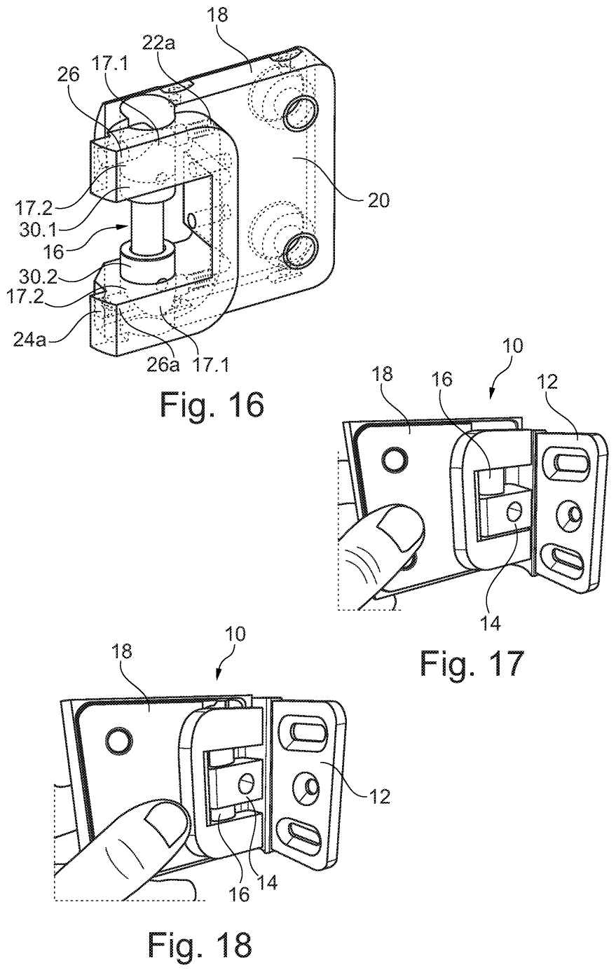

FIGS. 16 through 18 show the lift-and-lower hinge 10 in its assembly state, i.e., prior to final assembly or prior to its operating state. In this context, the embodiment of the lift-and-lower hinge 10 shown in FIG. 17 corresponds to or incorporates, for example, the bolt assembly configuration shown in FIG. 9 in a similar design. All lift-and-lower hinges 10 are designed such that they have at least one bolt assembly 26 in the upper horizontal leg recess 22a, with the lift-and-lower hinge 10 shown in FIG. 17 having exactly one bolt assembly 26 in the upper horizontal leg recess 22a. In contrast, it is directly apparent in FIG. 16 and apparent by technical implication in FIG. 18 that the lift-and-lower hinge 10, in its assembly state, additionally comprises a second bolt assembly 26a in the second horizontal leg recess 24a, wherein both bolt assemblies 26, 26a are arranged in the horizontal leg recesses 22a, 24a such that they are each positioned in the curve trough 17.2 of the curve profile 17 associated with them.

FIG. 17 shows a vertical offset between the first hinge part 12 and the second hinge part 18, which must generally be compensated for during assembly by actively holding the first hinge part 12 up during installation.

In other words, as a variant to FIG. 17, FIGS. 16 and 18 show that, in addition to the upper bolt assembly 26 required for the lift-and-lower function, the lower bolt assembly 26a is also screwed in, which facilitates assembly. This prevents the first hinge part 12 from falling vertically or shifting vertically, as it is held in place by the lower bolt assembly 26a.

Once assembly is complete, the lower, second bolt assembly 26a can then be removed from the lower horizontal leg recess 24a, so that the lift-and-lower hinge 10 transitions from its assembly state to its operating state. This occurs regardless of whether the lift-and-lower hinge 10 is DIN left or DIN right.

### LIST OF REFERENCE SYMBOLS

10 Lift-and-lower hinge
10a Central horizontal plane of the lift-and-lower hinge
12 First hinge part
14 Bearing means
14a Vertical opening of the bearing means
16 Pivot axle assembly
16a Vertical bearing axis
17 Curve profile
17.1 Curve crest
17.2 Curve trough
18 Second hinge part
20 Base of the second hinge part
22 Leg of the second hinge part, e.g., originally at the top
22a Horizontal leg recess of the originally upper leg
22b Vertical leg recess of the originally upper leg
24 Leg of the second hinge part, e.g., originally at the bottom
24a Horizontal leg recess of the originally lower leg
24b Vertical leg recess of the originally lower leg
26 First bolt assembly
26a Second bolt assembly
28 Axle section
29 Flat of the curve crest
30.1 Bolt-assembly guide head
30.2 Bolt-assembly guide head

What is claimed is:

1. A lift-and-lower hinge for supporting a glass door, the lift-and-lower hinge (10) comprising:
at least one first hinge part (12) with a bearing means (14) arranged thereon, wherein the bearing means (14) comprises a continuous vertical opening (14a) for supporting a pivot axle assembly (16);
at least one pivot axle assembly (16) with a vertical bearing axis (16a), wherein the pivot axle assembly (16) is configured to rotatably connect the first hinge part (12) to a second hinge part (18),
wherein the pivot axle assembly (16) comprises, on each end face, a curve profile (17) with at least one curve crest (17.1) and one curve trough (17.2);
at least one second hinge part (18) having a U-shape with a base (20) and two legs (22, 24), wherein the second hinge part (18) is rotatably connected to the bearing means (14), at least indirectly via the pivot axle assembly (16),
wherein each leg (22, 24) comprises a respective horizontal leg recess (22a, 24a) configured for supporting a bolt assembly (26), and a respective vertical leg recess (22b, 24b) for supporting the pivot axle assembly (16), wherein the pivot axle assembly (16), the vertical bearing axis (16a), and the two vertical leg recesses (22b, 24b) are coaxial with one another;
at least one bolt assembly (26) configured to be selectively insertable into one of the two horizontal leg recesses (22a, 24a) so as to interact, when inserted into one of the two horizontal leg recesses (22a, 24a), with the curve profile (17) of the pivot axle assembly (16) in such a way that a rotation of the second hinge part (18) relative to the first hinge part (12) is accompanied simultaneously by a vertical offset of the second hinge part (18) relative to the first hinge part (12).

2. The lift-and-lower hinge according to claim 1, wherein
the first hinge part (12), the pivot axle assembly (16), and/or the second hinge part (18) are formed substantially mirror-symmetrically with respect to a central horizontal plane (10a) of the lift-and-lower hinge (10).

3. The lift-and-lower hinge according to claim 1, wherein
the bolt assembly (26) is formed in multiple parts, in particular comprising a screw and a pin, or as a single-piece fitting screw.

4. The lift-and-lower hinge according to claim 1, wherein
the curve profile (17) comprises a waveform with varying curve crest and/or curve trough slopes.

5. The lift-and-lower hinge according to claim 1, wherein
the pivot axle assembly (16) is formed monolithically or in one piece, in particular detachably in one piece.

6. The lift-and-lower hinge according to claim 1, wherein
the pivot axle assembly (16) comprises an axle (28) and, on each end face, a bolt-assembly guide head (30.1, 30.2) arranged on the axle (28), wherein each bolt-assembly guide head (30.1, 30.2) comprises a curve profile (17) on its end face.

7. The lift-and-lower hinge according to claim 1, wherein
the curve profile (17) comprises at least one or more detent positions for the bolt assembly (26) to hold the glass door in the closed position.

8. The lift-and-lower hinge according to claim 1, wherein
the curve profile (17) comprises at least two, in particular exactly two, curve crests (17.1) and at least two, in particular exactly two, curve troughs (17.2) as a continuous waveform.

9. The lift-and-lower hinge according to claim 1, wherein
the curve profile (17) comprises an even number of curve crests (17.1) and an even number of curve troughs (17.2) as a continuous waveform.

10. The lift-and-lower hinge according to claim 1, wherein
the curve profile (17) comprises at least two diametrically opposed curve crests (17.1) and curve troughs (17.2).

11. The lift-and-lower hinge according to claim 1, wherein
the curve profile (17) comprises at least two or more diametrically opposed curve troughs (17.2) to automatically hold the glass door in the closed position.

12. The lift-and-lower hinge according to claim 1, wherein
at least one curve crest (17.1), preferably several curve crests (17.1), most preferably all curve crests (17.1), in particular in the region of their apex, each comprises or comprise a flat (29), in particular of bowl-shaped configuration.

13. The lift-and-lower hinge according to claim 1, wherein
the lift-and-lower hinge comprises at least one spring element and/or damping element in the region of the pivot axle assembly (16) or the bolt assembly (26) to assist or dampen the opening and/or closing.

14. The lift-and-lower hinge according to claim 1, wherein
the second hinge part (18) is designed to allow the glass door to swing open on both sides, such that the glass door can be swung out of the closed position in both a first direction and an opposite direction.

15. The lift-and-lower hinge according to claim 1, wherein
at least one or more stop means is/are provided, which limit the rotation of the second hinge part (18) in at least one or both directions of rotation.

16. The lift-and-lower hinge according to claim 1, wherein
the second hinge part (18) and the first hinge part (12) are formed such that, in a closed position, they are substantially flush with an adjacent surface.

17. The lift-and-lower hinge according to claim 1, wherein
an adjustment means is provided to readjust the position of the second hinge part (18) relative to the first hinge part (12) in a transverse direction or in the direction of the vertical bearing axis (16a).

18. The lift-and-lower hinge according to claim 1, wherein
the pivot axle assembly (16) is substantially dumbbell-shaped, comprising two end-face bolt-assembly guide heads (30.1, 30.2) and a narrower axle section (28) located between them.

19. The lift-and-lower hinge according to claim 1, wherein
the lift-and-lower hinge (10) in its operating state, i.e., after the lift-and-lower hinge (10) has been installed, or, in other words, after its assembly state, comprises exactly one bolt assembly (26) in the upper horizontal leg recess (22a, 24a),
wherein the lift-and-lower hinge (10) in its assembly state additionally comprises a second bolt assembly (26a) in the second horizontal leg recess (22a, 24a),
wherein, in the assembly state of the lift-and-lower hinge (10), both bolt assemblies (26, 26a) are arranged in the horizontal leg recesses (22a, 24a) such that they are each positioned in the curve trough (17.2) of the curve profile (17) associated with them.

20. A method of installing the lift-and lower hinge of claim 1, the method comprising the step of attaching the lift-and-lower-hinge of claim 1 to a glass door.
